(19) United States
(12) Patent Application Publication
(10) Pub. No.: US 2006/0182551 A1
(43) Pub. Date: Aug. 17, 2006

(54) Storage and retrieval unit and high-bay store having such a unit

(76) Inventor: Heiko Suess, Graz (AT)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/321,397

(22) Filed: Dec. 29, 2005

(30) Foreign Application Priority Data
Dec. 30, 2004 (DE) 102004063588.9

(51) Int. Cl. B65G 65/00

(52) U.S. Cl. 414/277

(57) ABSTRACT

In order to increase the output capacity of a storage and retrieval unit having a lifting table that can be raised and lowered on a vertical guide, the lifting table may be provided with a buffer store. The buffer store includes storage spaces that can be moved vertically such that a plurality of load carriers can be transported simultaneously by the storage and retrieval unit for the purpose of storage or retrieval.

### BACKGROUND AND FIELD OF THE INVENTION

The invention relates to a storage and retrieval unit and to a high-bay store having such a storage and retrieval unit.

Storage and retrieval units for the automatic storage and retrieval of unit load carriers in and from a high-bay store have belonged to the prior art for many years. Suitable unit load carriers having fixedly predefined dimensions are, for example, pallets, trays or box-shaped containers. The latter are usual in particular in what are known as automatic small parts stores in order to accommodate the individual parts to be stored and having a large number of different dimensions. The respective load carrier having the goods to be stored is moved by the storage and retrieval unit to a free storage point in the store and is retrieved from the latter again as required on the basis of appropriate requests by the storage administration system to the electronic control system of the storage and retrieval unit.

For example, a storage and retrieval unit for a high-bay small parts store is known from DE 91 03 198 U1. In this high-bay store, the load carriers are put into the store two deep, that is to say in each case two load carriers can be put into the store one behind the other at a storage point. This storage and retrieval unit has a chassis with which it can be moved horizontally to any desired points within a storage aisle of the high-bay store. Arranged on the chassis as a vertical guide is a mast, on which a lifting table can be moved vertically. The lifting table is provided with a transfer unit, by means of which a load carrier loaded in a storage region can be moved to the respectively desired storage point and put into store there in the high-bay store or, in the converse case, can be retrieved from the store again at this storage point and can be discharged to the outside in a retrieval region. All the drives of the storage and retrieval unit, that is to say the drives for moving the storage and retrieval unit and its lifting table in the horizontal and vertical direction and also for actuating the transfer unit, are controlled by an electronic control system. In order to increase the output capacity of the storage and retrieval unit as compared with a storage and retrieval unit which can transport only a single load carrier in each case, that is to say to increase considerably the number of load carriers that can be put into the store and retrieved from the latter in a predefined time period, the lifting table of the storage and retrieval unit disclosed by DE 91 03 198 U1 is not just provided with a central transfer section, by using which the actual storage and retrieval operation can be carried out, but this central transfer unit is flanked on one side by a retrieval section and on the other side by a storage section. In the storage section, in accordance with the storage in the storage points of the high-bay store, two load carriers to be put newly into the store can be accommodated in each case, while the retrieval section can accommodate two load carriers to be retrieved in each case. Furthermore, a transfer apparatus is provided on the lifting table, by using which load carriers on the lifting table can be displaced horizontally as required between the storage section and the central transfer section or between the central transfer section and the retrieval section. The operation of this storage and retrieval unit is designed in such a way that in each case two load carriers are loaded onto the storage section of the lifting table, the storage and retrieval unit is then moved to the respectively desired free storage space in the high-bay store and the storage is then performed after displacing the load carriers into the central transfer section. It is also possible to move to the storage point of two load carriers to be retrieved from the store, to pick the latter up with the aid of the central transfer section and to displace them into the retrieval section of the lifting table by using the transfer apparatus, in order, after that, to perform the storage of the two load carriers also carried along in the storage section at this storage point. Of course, this unit can also be used to store and retrieve only single load carriers. Here, it is for example also possible, if only a rear load carrier is to be retrieved from a storage point, firstly to pick up both load carriers stored at this storage point onto the lifting table with the aid of the central transfer section, to displace only the desired load carrier into the retrieval section and to put the unneeded load carrier into store again.

In order to shorten the necessary storage and retrieval times in a high-bay store, it is known to provide the storage and retrieval unit used in each case with a lifting table which is equipped with a plurality of parallel transfer units, so that a corresponding number of storage points arranged immediately beside one another can be served virtually simultaneously with regard to the storage or retrieval. Examples of this are the storage and retrieval units of the AKL 100 type, which can be procured from Siemens AG, in the design having two load-lifting means (transfer units) or of the AKL Multistore type, even having three load-lifting means arranged beside one another on the lifting table. However, these high-capacity storage and retrieval units require a comparatively great deal of effort on construction and entail a not inconsiderable additional weight for the additional transfer units.

### SUMMARY OF THE INVENTION

It is an object of the present invention to improve a generic storage and retrieval unit substantially in terms of its output capacity with regard to faster storage and retrieval with the least possible effort on construction, and to propose a high-bay store having such a storage and retrieval unit.

Taking as its starting point a generic storage and retrieval unit with a lifting table having a single transfer unit, the present invention provides for the lifting table for the transport of load carriers between the storage region, the storage point and the retrieval region of the high-bay store to be provided with a buffer store, in which, in addition to accommodating a load carrier in the region of the transfer unit, at least one further load carrier can be accommodated. The buffer store should expediently have at least two, preferably three, storage spaces for load carriers. Within the context of the present invention, a storage space is to be understood to mean an intermediate storage point on the lifting table which, in its dimensions, corresponds to a storage space in the high-bay store. In the case of, for example, two-deep storage of load carriers, a storage space is therefore designed to accommodate two load carriers appropriately arranged one behind the other. In order to simplify the illustration, in the present application only the case in which a storage space is regularly occupied by only a single load carrier will be outlined. However, it goes without saying that the present invention can also be implemented in the same way with load carriers which actually comprise a plurality of subunits (e.g. load containers) and, for example, are constructed as load carrier pairs (two-deep storage) or load carrier triplets (three-deep storage) and so on.

The buffer store within the context of the present invention is constructed in such a way that, in order to be stored in the high-bay store, the at least one additional load carrier can be transferred into the operating region of the transfer unit and, vice versa, in order to be retrieved from store, can be transferred from the operating region of the transfer unit into the buffer store.

The storage spaces in the buffer store may be arranged one above another. In this way, the lateral movement dimension of the storage and retrieval unit can be kept considerably smaller as compared with a storage and retrieval unit having a plurality of load-lifting means arranged one beside another, since it is virtually not enlarged as compared with the known design having a single load-lifting means.

The storage spaces of the buffer store can expediently be raised and lowered, it being possible for all the storage spaces preferably to be raised and lowered in a coupled manner, that is to say simultaneously for all of the storage spaces. This may be achieved particularly simply if the buffer store is constructed as a lift device whose operating region is arranged above the transfer unit of the lifting table. Such a lift device can be formed with little outlay on construction and thus with comparatively low production costs as belts or chains circulating vertically, which are arranged at a distance from each other and opposite each other and which are provided with holding devices for the load carriers. Such holding devices can be constructed as simple angle supports. The load carriers used can then, for example, be set down with their base on the angle supports or, for example, have a holding collar, which is arranged laterally and with which they can be supported on the angle supports. In particular for the retrieval operation, it is expedient if the transfer unit of the lifting table is provided with a coupling device in order to couple it to a load carrier with a force or form fit, so that said load carrier can be pulled out of the storage point of the high-bay store. In order to put it into store, simply pulling it out by means of the transfer unit is often sufficient. The coupling device of the transfer device can expediently be constructed, for example, as a jaw and/or suction gripper. The coupling device can, however, also be provided with one or more gripping fingers for a form-fitting connection to the load carrier to be stored or retrieved. It is often sufficient to construct the coupling device as a driven conveyor which can be moved in the direction of the storage points of the high-bay store and on which the load carrier to be stored or retrieved rests and can be set down at the storage point of the high-bay store. In order to pick up a stored load carrier, the driven conveyor can be extended (telescoped) until it has moved completely under the load carrier. It is then raised slightly, in order to pick up the load carrier, and then moved back onto the lifting table. During storage, this procedure proceeds in the opposite sequence. Suitable driven conveyors are in particular belt conveyors or else roller or chain conveyors or other conveyors. The jaw grippers used can be, for example, horizontally circulating caterpillar belts. In principle, any desired transfer units and coupling devices can be used within the context of the invention.

A high-bay store according to the invention has at least one storage aisle, which has storage points for unit load carriers in each case on its two long sides. It has a storage region for the transfer of load carriers to be newly put into store and a retrieval region for the transfer of load carriers retrieved from store, and is provided with at least one storage and retrieval unit as described above, which conveys the load carriers between the storage region, the respective storage space in the high-bay store and the retrieval region. An automatic loading and unloading device may be provided in the storage region and/or in the retrieval region, which expediently form one functional unit, that is to say can be arranged at the same point, in order in particular to be able to perform the simultaneous loading and unloading of the storage spaces of the buffer store. This loading or unloading device is expediently constructed as a simple pusher, which pushes load carriers onto the storage spaces or off the latter.

The storage and retrieval unit according to the invention has a considerably higher capacity as compared with a conventional storage and retrieval unit having a single transfer unit on the lifting table. In the case of a storage and retrieval unit having a buffer store which has three storage spaces, so that, including the space in the operating region of the transfer unit itself, a total of four load carriers can be transported simultaneously, for example in a small parts store with a length of about 30 m and conventional speeds of travel, an increase of about 70% in the output capacity can be expected. As compared with a storage and retrieval unit having a plurality of load-lifting means on the lifting table, the costs are considerably lower, since a buffer store in the form of a lift device having vertically circulating belts is available inexpensively as a standard subassembly. Furthermore, the increase in weight caused by the buffer store is comparatively low.

These and other objects, advantages, purposes and features of the invention will become apparent upon review of the following specification in conjunction with the drawings.

### BRIEF DESCRIPTION OF THE DRAWINGS

FIG. 1A is a side elevation view of a storage and retrieval unit according to the present invention;

FIG. 1B is a front elevation view of the storage and retrieval unit of FIG. 1A;

FIG. 2 is a front elevation view of the storage and retrieval unit of FIG. 1A positioned in the storage and retrieval region of a partially illustrated high-bay store;

FIG. 3 is a buffer store shown removed from a storage and retrieval unit according to the present invention; and

FIG. 4 illustrates a travel path of a storage and retrieval unit along a storage aisle of a high-bay store over four storage points and four retrieval points.

### DESCRIPTION OF THE PREFERRED EMBODIMENTS

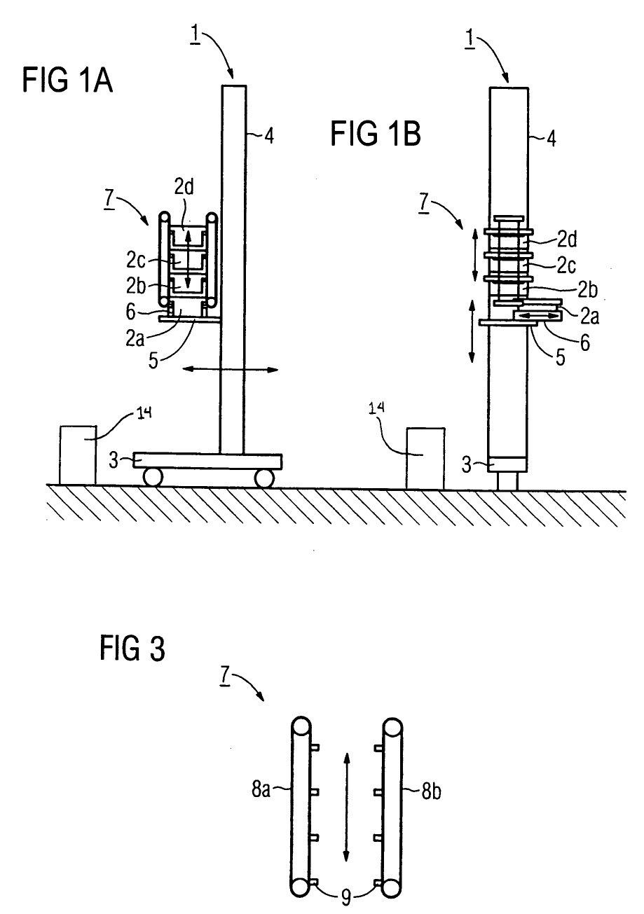

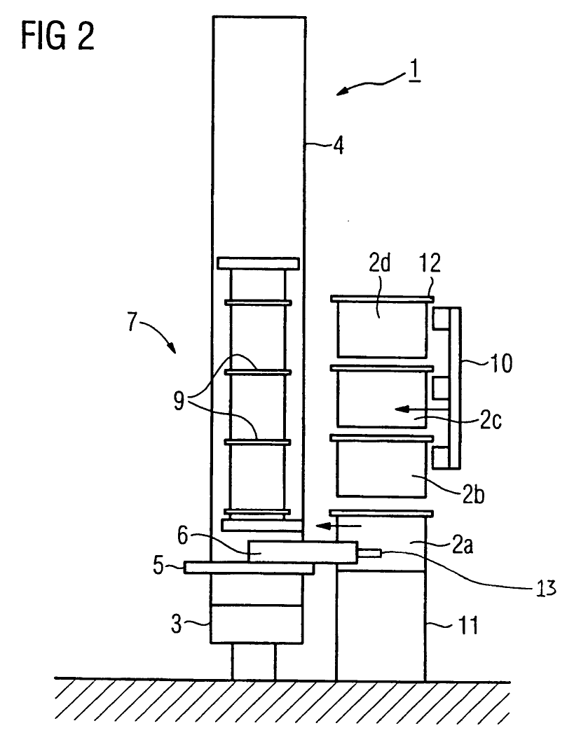

A storage and retrieval unit 1, as illustrated in FIGS. 1A and 1B, has a chassis 3, with the aid of which it can be moved horizontally in a storage aisle of a high-bay store. Provided on the chassis 3, in the form of a vertical mast, is a vertical guide 4 for a lifting table 5 which, as illustrated by the double arrow in FIG. 1B, can be raised and lowered. Firmly connected to the lifting table 5 is a buffer store 7, which has a plurality of storage spaces arranged one above another for load carriers 2. As indicated by the vertical double arrow in FIGS. 1A and 1B, the storage spaces of the buffer store can be moved upward and downward relative to the lifting table 5. The construction of the buffer store 7 is generally illustrated in FIG. 3. The buffer store 7 includes a lift device illustrated as two vertically circulating chains or belts 8a, 8b, which are opposite to, parallel to and at a distance from each other. The belts 8a, 8b can be driven reversibly. A feature of the belts 8a, 8b is a plurality of angle supports 9, preferably arranged at equal intervals from one another, which run horizontally. When the belts 8a, 8b are driven, these angle supports 9 are thus moved upward or downward, depending on the drive direction. A load carrier 2 which rests on corresponding angle supports of the two belts 8a, 8b is thus also moved inevitably upward or downward as the belts move. In FIGS. 1A and 1B, a plurality of load carriers 2a to 2d in the form of storage boxes can be seen which, for example at their upper edge, have a peripheral holding collar 12 (FIG. 2), with which they can rest on the angle supports 9 (suspended mounting). In FIGS. 1A and 1B, the three load carriers 2b, 2c and 2d are each accommodated in a storage space of the buffer store 7. The load carrier 2a is illustrated as being pulled onto the lifting table 5 by the transfer unit 6 of the lifting table 5, the transfer unit 6 being provided with a coupling device 13 (FIG. 2) such as a jaw gripper, suction gripper, gripping finger, driven conveyor, or the like, (retrieval from a storage space of the high-bay store) or pushed off the lifting table 5 (storage in a free storage space of the high-bay store). The high-bay store itself is not specifically illustrated in FIGS. 1A and 1B. An electronic control system 14 is illustrated in FIGS. 1A and 1B that may operatively control the drives of the storage and retrieval unit 1 to control the movement of both the storage and retrieval unit 1 and lifting table 5, as well as actuate the transfer unit 6.

In FIG. 2, the storage region of a high-bay store is illustrated. This storage region can also be used as a retrieval region at the same time, given appropriately reversed functionalities. The transfer of four load carriers 2a to 2d onto the lifting table 5 of the storage and retrieval unit 1 is illustrated. The lower load carrier 2a rests directly on a schematically indicated conveyor 11, which is used to feed load carriers 2 to the high-bay store, and is located at the height corresponding to that of the lifting table 5. Therefore, the load carrier 2a can be gripped by a jaw gripper, or the like, of the transfer unit 6 and pulled directly onto the lifting table 5. The further load carriers 2b, 2c and 2d are arranged above the load carrier 2a and rest on supporting elements, not illustrated, of the storage region of the high-bay store. They are arranged in a vertical position such that their holding collars 12 are located slightly above the respectively associated angle support 9 of the buffer store 7. A pusher 10, or the like, is adapted to push or move in accordance with the arrow shown, the three load carriers 2b, 2c, 2d, in the direction of the buffer store 7 until the holding collars 12 are resting on the angle supports 9. After that, all four load carriers 2a to 2d can be taken along simultaneously by the storage and retrieval unit 1 in a single transport operation. The retrieval proceeds conversely in a corresponding manner, which means that the load carriers 2 transported up can be pushed out of the buffer store 7 to the right by a second pusher, not illustrated, in order to discharge them to the outside. The lowest load carrier 2a is discharged by means of the transfer unit 6. Of course, it would also be possible to perform the unloading toward the left-hand side of the storage and retrieval unit 1, so that the pusher 10 could also be used for this purpose. Then, however, of course corresponding holding devices for the outward transport of the load carriers 2 retrieved from store would have to be provided on this left-hand side.

Then, when the loaded storage and retrieval unit 1 has reached the storage point at which the first load carrier 2a is to be discharged, the transfer to the respective storage space of the high-bay store is carried out by means of the transfer unit 6. After the load carrier 2a has been put into store, a move is made to the next storage space (storage point) in the high-bay store, at which the load carrier 2b is to be discharged. During the travel, the buffer store 7 is moved downward by one position for this purpose, so that the load carrier 2b comes directly into the operating region of the transfer unit 6. It can then be put into store in a corresponding manner to the load carrier 2a. In the same way, the procedure is then carried out with the two load carriers 2c and 2d. Following complete unloading, the storage and retrieval unit 1 can then move to four storage points (retrieval points) of the high-bay store one after another, in order from there to pick up load carriers to be retrieved. In this case, the retrieval is carried out in a corresponding way with the converse movement sequence. As soon as a load carrier 2 has been transferred onto the lifting table 5 by the transfer unit 6, it is moved upward by one position by moving the circulating belts 8a, 8b of the buffer store 7, so that the space in the operating region of the transfer unit 6 becomes free again to accommodate the next load carrier to be retrieved from store, with which the procedure is carried out in the corresponding way. After that, it is then possible to move to two further retrieval points, in order to pick up further load carriers from there. The fully loaded storage and retrieval unit 1 is then moved to the retrieval region of the high-bay store, in order to discharge, in the manner already described above, the load carriers picked up. Of course, it is possible to carry out a storage cycle or else a retrieval cycle as required with an only partly loaded storage and retrieval unit 1.

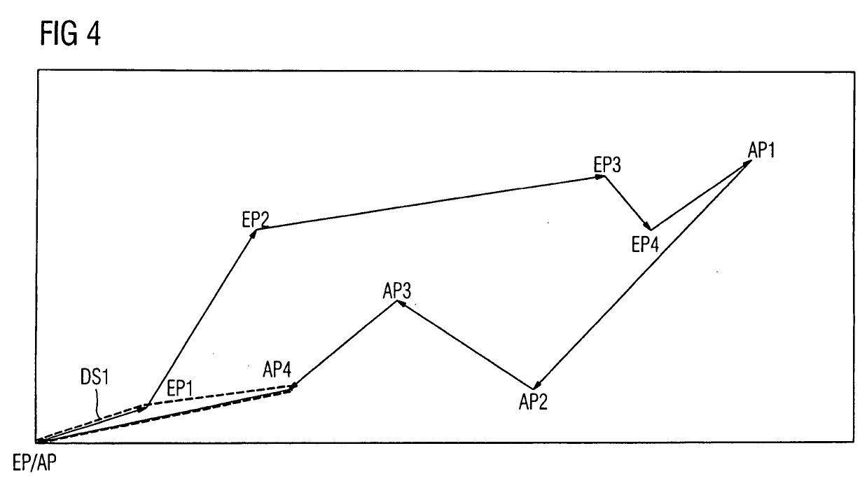

The output capacity of the storage and retrieval unit constructed in accordance with the invention is made clear from the storage and retrieval cycle in a high-bay store illustrated schematically in FIG. 4. The storage points of the high-bay store, which are not illustrated in detail, lie within the rectangle shown. The combined storage and retrieval region is designated EP/AP. The travel paths of the lifting table 5 of the storage and retrieval unit 1 are indicated schematically in the form of arrows, with which paths the intention is to reach four storage points EP1 to EP4 and four retrieval points AP1 to AP4, in order there to store and retrieve load carriers 2, respectively. In the case of a conventional storage and retrieval unit having only a single load-lifting means and without a buffer store, four double storage cycles, as they are known, would be needed for this purpose. One of these double storage cycles DS1 is indicated by the additional dashed lines. It provides firstly for the storage of a load carrier at the point EP1, then the onward travel to the retrieval point AP4, in order to retrieve a load carrier there, and then the return travel to the storage/retrieval region EP/AP in order to discharge the load carrier retrieved from store. In the next double cycle, it would be possible to move to the two points EP2 and AP3, to the points EP3 and AP2 in a further double cycle and finally to the points EP4 and AP1 in the fourth double cycle. Given a distance of the point AP1 placed the furthest from the storage/retrieval region EP/AP of 28.5 m, for example, in the horizontal direction, these four double cycles would require a time of about 108 seconds in the case of a known storage and retrieval unit, which corresponds to a capacity of 133 double cycles per hour. However, with the storage and retrieval unit 1 according to the invention, the storage and retrieval would be carried out in accordance with the course of the arrows shown, firstly via the storage points EP1 to EP4 and then via the retrieval points AP1 to AP4 and back to the storage/retrieval region EP/AP. As a result of the drastic reduction in distance achieved in this case because of the saving of substantial parts of outward and return paths, a time requirement of barely 62 seconds would result, on the basis of unchanged speed data of the storage and retrieval unit 1. Converted into the number of corresponding “classical” double storage cycles, this signifies an imaginary increase in the output capacity of the storage and retrieval unit 1 to 233 double cycles per hour.

Changes and modifications in the specifically described embodiments can be carried out without departing from the principles of the present invention, which is intended to be limited only by the scope of the appended claims, as interpreted according to the principles of patent law including the doctrine of equivalents.

1. A storage and retrieval unit for storing and retrieving unit load carriers in and from a high-bay store, said storage and retrieval unit comprising:
a chassis adapted for horizontal movement within a storage aisle of the high-bay store;
a lifting table movable on a vertical guide and adapted to transport load carriers, said lifting table being provided with a transfer unit adapted to store and retrieve a load carrier in and from a storage point of the high-bay store;
an electronic control system adapted to control the movement of the storage and retrieval unit; and
a buffer store adapted to accommodate at least one load carrier in addition to a load carrier accommodated by said transfer unit;
said buffer store and said lifting table being adapted to selectively exchange the at least one additional load carrier for storage into or retrieval from the high-bay store by said transfer unit.

2. The storage and retrieval unit of claim 1, wherein said buffer store has at least two storage spaces for load carriers.

3. The storage and retrieval unit of claim 2, wherein said buffer store has three said storage spaces.

4. The storage and retrieval unit of claim 2, wherein said storage spaces are arranged one above another.

5. The storage and retrieval unit of claim 4, wherein said storage spaces can be raised and lowered.

6. The storage and retrieval unit of claim 5, wherein said storage spaces can be raised and lowered in a coupled manner.

7. The storage and retrieval unit of claim 4, wherein said buffer store is constructed as a lift device having an operating region arranged above said transfer unit.

8. The storage and retrieval unit of claim 7, wherein said lift device is formed as at least one selected from the group consisting of belts and chains circulating vertically and arranged at a distance from and opposite each other and provided with holding devices for the load carriers.

9. The storage and retrieval unit of claim 8, wherein said holding devices are constructed as angle supports.

10. The storage and retrieval unit of claim 1, wherein said transfer unit is provided with a coupling device adapted to couple said transfer unit to a load carrier.

11. The storage and retrieval unit of claim 10, wherein said coupling device is constructed as at least one selected from the group consisting of a jaw gripper and a suction gripper.

12. The storage and retrieval unit of claim 10, wherein said coupling device is constructed as a driven conveyor, said driven conveyor being moveable in the direction of the storage points of the high-bay store and adapted to support the load carriers to be stored or retrieved.

13. The storage and retrieval unit of claim 10, wherein said coupling device is provided with at least one gripping finger adapted to provide a form-fitting connection to the load carrier to be stored or retrieved.

14. A high-bay store, said high-bay store comprising:
at least one storage aisle with storage points arranged on both sides of said storage aisle for unit load carriers;
at least one storage and retrieval unit;
a storage region for the transfer of load carriers to be newly put into store by said storage and retrieval unit; and
a retrieval region for the transfer of the load carriers retrieved by said storage and retrieval unit;
wherein said at least one storage and retrieval unit comprises;
a chassis adapted for horizontal movement within a storage aisle of the high-bay store;
a lifting table movable on a vertical guide and adapted to transport load carriers, said lifting table being provided with a transfer unit adapted to store and retrieve a load carrier in and from a storage point of the high-bay store;
an electronic control system adapted to control the movement of the storage and retrieval unit; and
a buffer store having at least one storage space for load carriers, said buffer store being adapted to accommodate at least one load carrier in addition to a load carrier accommodated by said transfer unit;
said buffer store and said lifting table being adapted to selectively exchange the at least one additional load carrier for storage into or retrieval from the high-bay store by said transfer unit.

15. The high-bay store of claim 14, further including an automatic loading and unloading device adapted for loading and unloading of said at least one storage space of said buffer store, said automatic loading and unloading device being provided in at least one selected from the group consisting of said storage region and said retrieval region.

16. The high-bay store of claim 15, wherein said buffer store includes at least two said storage spaces, and wherein said loading and unloading device is adapted to simultaneously load or unload each said at least two storage spaces of said buffer store.

17. The high-bay store of claim 15, wherein said loading and unloading device is in each case constructed as a pusher.

18. The high-bay store of claim 14, wherein said storage region forms a common functional unit with said retrieval region.
